(19) United States
(12) Patent Application Publication
(10) Pub. No.: US 2023/0089259 A1
(43) Pub. Date: Mar. 23, 2023

(54) Fast Battery Charging Method and System for Large Power Load Applications

(71) Applicant: The Boeing Company, Chicago, IL (US)

(72) Inventor: Morteza Safai, Newcastle, WA (US)

(21) Appl. No.: 17/990,892

(22) Filed: Nov. 21, 2022

Related U.S. Application Data
(63) Continuation-in-part of application No. 17/126,930, filed on Dec. 18, 2020, now Pat. No. 11,518,260.

(51) Int. Cl. B60L 53/55; B60L 53/51; B60L 53/52; B60L 53/62; B60L 53/18; H02J 7/34

(52) U.S. Cl. CPC B60L 53/55; B60L 53/51; B60L 53/52; B60L 53/62; B60L 53/18; H02J 7/345

(57) ABSTRACT

A system for charging vehicles. The system includes a renewable energy collection device configured to collect renewable energy from one or more renewable energy sources. The system includes various components configured to store and deliver the electrical energy for dispensing. The system is further configured to receive energy from a power grid. The energy from the power grid can supplement the energy available in the system and/or supply the energy for dispensing.

### RELATED APPLICATIONS

This application is a continuation-in-part application of U.S. application Ser. No. 17/126,930 filed Dec. 18, 2020 which is herein incorporated by reference in its entirety.

### TECHNOLOGICAL FIELD

The present disclosure relates generally to the field of harvesting renewable energy and energy distribution for charging large vehicle demands. More specifically the present disclosure relates to the field of energy capture, storage, and distribution.

### BACKGROUND

Since their incorporation into today's society, large vehicles comprising combustion engines continue to require the use of fossil fuels as a source of combustible power generation. While alternative energy sources that minimize or eliminate the use of fossil fuels have gained some traction in the automobile industry, the operation of large vehicles, including passenger and cargo aircraft have not incorporated alternative power generation, mostly due to the significant amount of power required to operate such vehicles that require significant energy to operate for extended duration over significant distances. Unless explicitly identified as such, no statement herein is admitted as prior art merely by its inclusion in the Background Section.

### SUMMARY

One aspect is directed to a system for charging vehicles. The system comprises: a renewable energy collection device configured to collect renewable energy from one or more renewable energy sources with the renewable energy source comprising at least one of solar power, wind power, and hydroelectric power; a high-voltage capacitor in communication with the renewable energy collection device; a first high temperature superconducting cable in communication with the high-voltage capacitor; a transformer in communication with the first high temperature superconducting cable; a second high temperature superconducting cable in communication with the transformer; an electrical energy storage bank; a power grid connection to receive energy from a power grid; and at least one demultiplexer in communication with the second high temperature superconducting cable and configured to engage a relay circuit with the relay circuit configured to deliver electrical energy to at least one rechargeable vehicle battery. The at least one demultiplexer is configured to deliver electrical power up to 1000 MW to at least one of the electrical energy storage bank and the at least one vehicle battery.

In another aspect, the power grid connection is configured to electrically connect the high-voltage capacitor to the power grid.

In another aspect, a converter converts the energy from the power grid into a form for receipt by the high-voltage capacitor.

In another aspect, the power grid connection is configured to electrically connect the electrical energy storage bank to the power grid.

In another aspect, the power grid is connected to both of the high-voltage capacitor and the electrical energy storage bank.

In another aspect, the system has an operating temperature range ranging from −30° C. to 45° C.

In another aspect, the at least one demultiplexer comprises relay mechanisms configured to distribute a predetermined amount of the electrical energy to the at least one vehicle battery.

In another aspect, the renewable energy collection device is configured to deliver up to 250 MW to the high-voltage capacitor.

One aspect is directed to a method of charging a battery of a vehicle. The method comprises: receiving at a charging system renewable electrical energy from one or more renewable energy sources; determining that an additional amount of the electrical energy is needed; in response to determining that the additional electrical energy is needed, receiving at the charging system additional electrical energy from a power grid; and dispensing from the charging system electrical energy comprising both the renewable electrical energy and the additional electric energy and charging the battery of the vehicle.

In another aspect, the method further comprises directing the electrical energy to a demultiplexer prior to dispensing the electrical energy and charging the battery of the vehicle.

In another aspect, dispensing the electrical energy comprises dispensing a first portion of the electrical energy from the demultiplexer and charging the battery with the method further comprising directing a second portion of the electrical energy from the demultiplexer to an electrical energy storage bank that is separate from the battery of the vehicle.

In another aspect, the method further comprises directing the first portion of the electrical energy to the battery prior to receiving the additional electrical energy.

In another aspect, the method further comprises receiving the additional electrical energy at the electrical energy storage device.

In another aspect, the demultiplexer if a first demultiplexer and the method further comprises: directing the electrical energy from the electrical energy storage bank to a second demultiplexer; and dispending the electrical energy from the second demuliplexer to the battery of the vehicle.

In another aspect, the method further comprises simultaneously directing the electrical energy from the first demuliplexer and the second demultiplexer to the battery.

In another aspect, the method further comprises converting the renewable electrical energy to a different form prior to dispensing the electrical energy.

In another aspect, the method further comprises receiving the additional electrical energy from the power grid at a high-voltage capacitor.

In another aspect, receiving the renewable electrical energy from the one or more renewable energy sources comprises receiving the renewable electrical energy from at least one of solar power, wind power, and hydroelectric power.

In another aspect, the method further comprises dispensing the electrical energy to the battery of the vehicle at a charging rate ranging between 100 kWh to 100 MWh.

One aspect is directed to a method of charging a vehicle. The method comprises: collecting renewable energy from a renewable energy source to form collected electrical energy; converting the collected electrical energy into converted electrical energy; directing the converted electrical energy via a high temperature super conducting cable to a first demultiplexer; distributing the converted electrical energy from the first demultiplexer to a battery of a vehicle and thereby charging the battery; maintaining a temperature in a charging region of the battery below 45° C. during the charging; distributing the converted electrical energy from the first demultiplexer to an electrical energy storage bank; and distributing the converted electrical energy from the electrical energy storage bank to a second demultiplexer. An amount of electrical energy that is distributed ranging from 250 MW to 1000 MW from the second demultiplexer to the battery at a charging rate ranging from 1 MWh to 100 MWh.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is an illustration of a renewable energy collection, storage, and charging system, according to present aspects;

FIG. 2 is partially exposed view of a high temperature super conducting cable according to present aspects;

FIG. 3 is a graph plotting resistivity versus temperature;

FIG. 4 is an illustration of a demultiplexer used according to present methods;

FIG. 5 is an illustration of a demultiplexer used according to present aspects;

FIG. 6 is a flowchart illustrating a method according to present aspects;

FIG. 7 is a flowchart illustrating a method according to present aspects;

FIG. 8 is a flowchart illustrating a method according to present aspects;

FIG. 9 is a flowchart illustrating a method according to present aspects; and

FIG. 10 is a flowchart illustrating a method according to present aspects.

FIG. 11 is an illustration of a system for charging vehicles and with the system connected to a power grid, according to present aspects;

FIG. 12 is a flowchart illustrating a method according to present aspects; and

FIG. 13 is a schematic diagram of a grid controller.

### DETAILED DESCRIPTION

Present systems, methods and apparatuses are directed to the sustainable collection, conversion, storage, quick transfer, and efficient delivery of large amounts renewable energy (e.g., in the form of converted electricity) to vehicle battery cells, including the collection, conversion, transfer, and delivery of the renewable energy to rechargeable lithium ion vehicle battery cells and electrical energy storage banks (e.g., battery storage banks, etc.). Vehicles including, for example, a passenger or cargo aircraft can comprise rechargeable lithium ion vehicle battery cells (e.g., lithium ion vehicle battery cells, etc.) in such vehicles, with the vehicle battery cells charged via the systems and methods disclosed herein. According to present aspects, the entire presently disclosed systems and methods comprise collecting, converting, and delivering renewable energy in the form of electrical vehicle end-use charges “off-grid” with respect to a community or geographic area's energy demand and/or energy “draw”.

In the transportation industry, for example, there are significant practical issues facing the use of electricity as an energy source for rapid and schedule-sensitive charging of large vehicles, including, for example, passenger and cargo aircraft, as well as the rapid and schedule-sensitive charging of terrestrial vehicles and terrestrial vehicle fleets including, for example, cars, buses, trucks, etc.

Present aspects address the previous difficulties that can include the impact of a critical power drain on a geographic region during a significant diversion of vast amounts of electrical “power” required from a geographic power supply, or power “grid”, for large vehicle electrical charging of vehicle batteries (e.g., charging vehicle batteries substantially to the vehicle battery capacity) in a short duration. Further present aspects address prior electrical charging issues including, for example, the conditions for electrical energy transfer and storage (including, e.g., issues and conditions relating to, for example, powering of rechargeable batteries to capacity, heat generation, charging time, charging rate, etc.) that are required for the safe charging of large vehicles and the regular and frequent charging of a large number of ground vehicles, vehicle fleets, etc. (also referred to equivalently herein as “terrestrial vehicles”). Further present aspects address issues that have frustrated and otherwise have inhibited the practical adoption of electrical charging facilities for large vehicles and large numbers of vehicles requiring frequent, scheduled charging, and that can require large amounts of electrical energy transfer from renewable energy sources at fast charging rates.

Aspects of the present disclosure achieve a workable solution for the delivery of large amounts of electrical energy from a renewable energy source, without dedicating or diverting electrical energy from a geographic area's power grid. The delivery of such large energy amounts in this fashion is referred to herein as delivering collected energy “off-grid”.

Present aspects are further directed to methods, systems, and apparatuses for quickly charging and powering large vehicles and quickly charging and powering a large number of smaller vehicles especially when such frequent, scheduled charging must occur in a short timeframe (e.g. from about 10 minutes to about 50 minutes for terrestrial vehicles, and from about 60 minutes to 180 minutes for larger vehicle including, for example, aircraft, etc.), without sustaining a significant increase in localized system temperatures that ordinarily would occur with respect to the amount of electrical power transfer that would be required to be delivered to batteries from an electrical source in a workable (e.g., a condensed) charging time.

In addition, in the case of passenger and cargo aircraft, electrically powered aircraft must be able to travel significant distances on a single charge, and travel to varied destinations, requiring the existence of charging capabilities at multiple destinations along a particular aircraft's route (or e.g., otherwise have a travel range significantly shortened by the need to return to the location of the original charging station). Present aspects disclose systems for delivering electrical energy to substantially fully charge a bank of rechargeable batteries in an aircraft (e.g., a bank of rechargeable lithium ion batteries) that is sufficient to provide the aircraft with adequate power over a range suitable to complete a flight having a predetermined distance, charging the aircraft batteries in a short charging cycle of from about 1 to about 3 hours, and at a charging temperature that does not exceed about 45° C., and directing converted electrical energy to charge the vehicle batteries from a renewable energy source. “Substantially fully charging” a battery cell refers to the state of charging a battery cell to a battery cell charging capacity that may be a value less than 100% charges, but that is in excess of or equal to a rechargeable battery charging capacity that is equivalent to about 95% charged.

Present aspects are directed to methods, systems, and apparatuses that successfully enable the use of electrical energy captured from renewable energy sources with the electrical energy converted into and, if desired, also stored as converted electrical energy that can be quickly delivered to charge batteries of electrically powered vehicles, in daytime hours or nighttime hours, including, for example, small or large passenger aircraft and large cargo aircraft. Methods, apparatuses, and systems are set forth herein for collecting renewable energy, and converting, storing, and delivering amounts of renewable electrical energy directly to vehicle battery banks, and also to storage banks that can be located remotely from a vehicle without incurring significant and potentially dangerous heat increases, and, instead limits heat increases during a charging event to less than about 25° C. above an ambient temperature (e.g., a maximum heat increase of about 25° C. above an ambient temperature such as above a room temperature of about 20° C.). In other words, the present charging methods and systems occur at a maximum temperature of about 45° C. during the charging cycle duration. Further, the charging cycle can occur at an operating charging temperature ranging from about −30° C. to about 45° C.

According to present aspects, the charging event (equivalently referred to herein as “charging cycle”) delivers a full and substantially complete battery charge to rechargeable battery cells to power a large vehicle for predetermined operational ranges, while significantly reducing the time of a charging event to time frames that substantially meet acceptable refueling schedules (e.g., substantially matching or being only slightly longer than present passenger aircraft refueling times and schedules when refueling an aircraft with fossil fuels, etc.).

Present aspects further contemplate the storage of converted electrical energy (e.g., converted from renewable energy sources) into large storage banks from which the stored converted electrical energy can be distributed to rechargeable vehicle batteries to power vehicles including, for example, large passenger and large cargo aircraft, even during nighttime hours (e.g., hours when renewable solar energy cannot be harvested). Such contemplated storage bank include, for example and without limitation, large above-ground or below-ground structures that can comprise salt tanks, or other rechargeable devices that can be high volume rechargeable battery cells, etc. Such storage banks can be located proximate to, or remotely from the renewable electrical energy collection devices, capacitors, transformers, and end-use points of electrical energy distribution to rapidly recharge vehicles, including aircraft.

According to present aspects, renewable energy is collected, or “harvested”, from a renewable energy resource (referred to equivalently herein as a “renewable energy source”) that can be solar power, hydroelectric power, wind power, etc., by implementing a suitable energy collection device in proximity to (for example, within from about 0.1 miles to about 3 miles from) the point of energy discharge (e.g., the “charging station”) to achieve and facilitate the collection, storage, and delivery of the collected renewable energy at a scale that can collect electrical energy at a rate ranging from about 250 MW to about 1000 MW.

In the case of a solar panel array, for the purpose of collecting solar energy on a scale thought to be necessary to charge an energy storage bank that is to be used in presently disclosed systems, according to present aspects, the energy collection device (e.g., in the form of a solar panel array) can be configured to collect an amount of solar energy at a rate ranging from about 250 MW to about 1000 MW. By way of example as to scale or energy made available, according to present aspects, 10,000 solar panels producing more than 3.6 million KW hours annually can provide enough power for more than 325 average-sized US homes. The presently contemplated solar energy collection array can comprise any number of solar panels having a predetermined rated degree of collection efficiency, with the understanding that the array selected for use as a part of the presently disclosed systems collects an amount of solar energy at a rate ranging from at least about 250 MWh to about 1000 MWh per hour.

According to present aspects the methods, systems, and apparatuses integrate components into a system that collects, converts, and delivers vast amount of electrical energy required to make electrical powering of vehicles (including, e.g., aircraft) practical, convenient, and safe without diverting electrical energy from a geographic electric power grid. The present systems, that are discrete from any geographic power grid, include and integrate components capable of capturing or collecting renewable energy, and can position and locate the energy capture and collection components proximate to and in communication with (e.g., within miles or less) an energy storage and distribution facility that can directly deliver electrical energy converted from the renewable energy source to a vehicle for the purpose of charging, for example, a battery-operated vehicle or battery-containing hybrid vehicle.

According to present aspects, the incorporation of high temperature superconducting cables affords present systems with the capability of safely delivering converted electrical energy to a storage bank, or safely delivering converted electrical energy directly to an end vehicular charging use at high electrical discharge/charging rates. The incorporation of the high temperature superconducting cables in conjunction with the incorporated multiplexers and demultiplexers, creates a system that can deliver high amounts of electrical energy required to power and charge the batteries of electric vehicles efficiently, rapidly, and at safe charging temperatures during charging cycles of relatively short duration (e.g., from about 10 mins for cars, for example, up to from about 1 hour to about 3 hours for larger vehicles including, for example, aircraft). That is, according to present aspects, the disclosed methods, systems, and apparatuses achieve electrical discharge/charging rates on the order of 250 MW/hour (250 megawatts per hour; with one megawatt equal to 1,000 kilowatts and equal to 1,000,000 watts) to about 1000 MW/hour, without increasing localized temperature more than about 25° C. above ambient temperature (and not exceeding an operating temperature of about 45° C.), while operating at temperatures ranging from about −30° C. to about 45° C.).

The present methods, systems, and apparatuses therefore address and solve issues of overheating during the charging of electric vehicles that can require electrical power ranging from about 250 MW to about 1000 MW. Theoretical attempts to deliver this range of electrical energy without realizing and incurring a significant temperature increase (and risking system overheating and the attendant dangers of overheating including system damage, vehicle damage, injury, etc.), have previously required significantly long and slow charging durations (e.g., charging duration in excess of 24 hours, etc.).

For example, systems required to effectively and efficiently deliver electrical power on the order of 250 MW to 1000 MW in a useful and practical time frame (similar to the presently disclosed charging rate time frames) would otherwise result in significantly high temperatures (e.g., significantly higher than ambient temperatures such as, for example, temperatures ranging from about 150° C. to about 560° C.). In contrast, the presently disclosed systems achieve fast charging times and fast charging rates (e.g., from about 60 minutes to about 180 minutes or less for delivering electrical power at a rate ranging from about 250 MW to about 1000 MW to substantially fully charge large aircraft vehicle batteries and battery banks; and from about 10 to about 50 mins. or less for delivering electrical power at a rate ranging from about 25 MWh to about 100 MWh to charge terrestrial vehicle batteries and terrestrial vehicle battery banks substantially to capacity), while maintaining localized system temperatures (e.g., in a charging region proximate to the vehicle being charged) below about 45° C.

According to further aspects, the collection device is in communication with one or more high-voltage capacitor to act as photovoltaic inverters that convert the DC power produced by the solar cells into AC power, such that the collected or “harvested” renewable energy/solar power is stored (e.g., in a storage bank) in the form of electrical charges and the power can accrue or “build” a large total or cumulative voltage, with the capacitors then able to distribute the stored and converted voltage from the energy storage bank, on demand, including when solar energy is not available to be received (e.g., at nighttime, etc.).

According to further present aspects, transformers are used in presently disclosed power systems for transmission of power without losses at high voltages, and working, for example, on the principle of electromagnetic induction, to convert low voltages to high voltages and vice versa during energy transmission and distribution. According to a further present aspect, a capacitor is in communication with a power-conditioning device such as, for example, a transformer via a first high temperature superconducting (HTS) cable. The transformer converts the power from first (e.g. incoming) voltage and current level to a predetermined second voltage and current level (e.g., outgoing). In further aspects, the power-conditioning device is a power-reducing device such that the transformer facilitates a “step down” of a stored capacitor voltage prior to transferring or otherwise directing the converted electrical energy to further components in the present systems. According to further present aspects, present systems incorporate a second high-temperature superconducting cable that can be in direct communication with the transformer, with the second high-temperature superconducting cable being in further direct communication with a multiplexer. At least one multiplexer can be in communication with at least one of the capacitor and the transformer. According to further aspects, at least one of the capacitor and the transformer can incorporate or otherwise integrate a multiplexer.

The present first and second HTS cables disclosed herein include a cryogenic dielectric having a coaxial configuration comprising an HTS conductor cooled by liquid nitrogen flowing through a flexible hollow core, and an FITS return conductor cooled by circulating liquid nitrogen. The presence of the HTS cables facilitates a highly efficient energy transfer from capacitor to transformer, and from transformer to a multiplexer, a demultiplexer, etc. Further advantages of the use of the HTS cables in the present systems, apparatuses, and methods include large transmission capacity in a compact dimension, small transmission loss, enhanced control of or elimination of leakage of electro-magnetic field to the outside of the cable, small impedance, among other advantages, etc.

With respect to the presently disclosed incorporation of HTS cables, the electrical resistance is zero at temperatures below the critical temperature, so transmission loss is very small, with the no measurable electromagnetic field leakage outside the cable, eliminating eddy current loss from the electromagnetic field. HTS cable energy losses typically come from the alternating current (AC) loss that is comparable to the magnetization loss of the superconductor itself, the dielectric loss of the insulation, and the heat invasion through the thermal insulation piping. To maintain the presently disclosed HTS cables at a predetermined temperature, coolant from a cooling unit is compensates for this heat gain, and the electric power required for the cooling unit, whose efficiency at liquid nitrogen temperature is thought to be approximately 0.1, must be counted as an energy loss. Comparing 66 kV, 3 kA, 350 MVA class cables, the loss of the HTS cable is approximately half that (approximately 50%) of a conventional cable.

In addition, one characteristic of superconducting material is that the lower the operating temperature, the greater the amount of current that can flow. For example, when operating temperature is lowered from 77° K to 70° K, there is an approximately 30% increase in the current-carrying capacity. Further, HTS materials can conduct electricity without resistance when cooled sufficiently (below 77° K, or −196° C./−321° F. for the HTS cables) with liquid nitrogen or liquid helium, used to boost efficiency in some power grids. The tolerances of the HTS cables allows the use of the unusually slender copper core or “former”. See FIG. 3.

The significant amounts of energy provided by the system result, in part, from the multiplexing of voltages collected and harvested by the renewable energy collection device (e.g., solar panels, wind turbines, hydroelectric turbines, etc.). Multiplexers in the system in communication with at least one of the capacitor and transformer and can further be integrated into one or more of the capacitor and the transformer. The multiplexers selected for use in the present systems, and according to present aspects, are multiplexers that can increase the supply of renewable electrical energy charges and, in concert with the associated HTS cables used to transfer the renewable electrical energy through the present system, minimize energy loss as the renewable electrical energy is delivered from the multiplexers to the associated demultiplexers. As explained further herein, the demultiplexers are responsible for directing the collected, converted, and multiplexed renewable electrical energy at least one of the renewable electrical energy storage banks and the vehicle battery banks.

As stated herein, according to present aspects, the present systems can include at least one demultiplexer placed in communication with the transformer via a second HTS cable. The demultiplexers, in combination with associate relay circuits incorporated into or in communication with the demultiplexer are configured to separate energy received from the transformer or received from the storage banks (e.g., released on demand from the storage banks) into separate circuits and deliver electricity for an end use at predetermined voltages into separate receiving battery cells to substantially simultaneously charge (e.g., charge in parallel) a plurality of separate battery cells, or battery cell “banks”. Such charging scheme, according to present aspects, significantly reduces the overall charging time of a large object to be charged that comprises the battery cell banks (e.g., an aircraft, etc.).

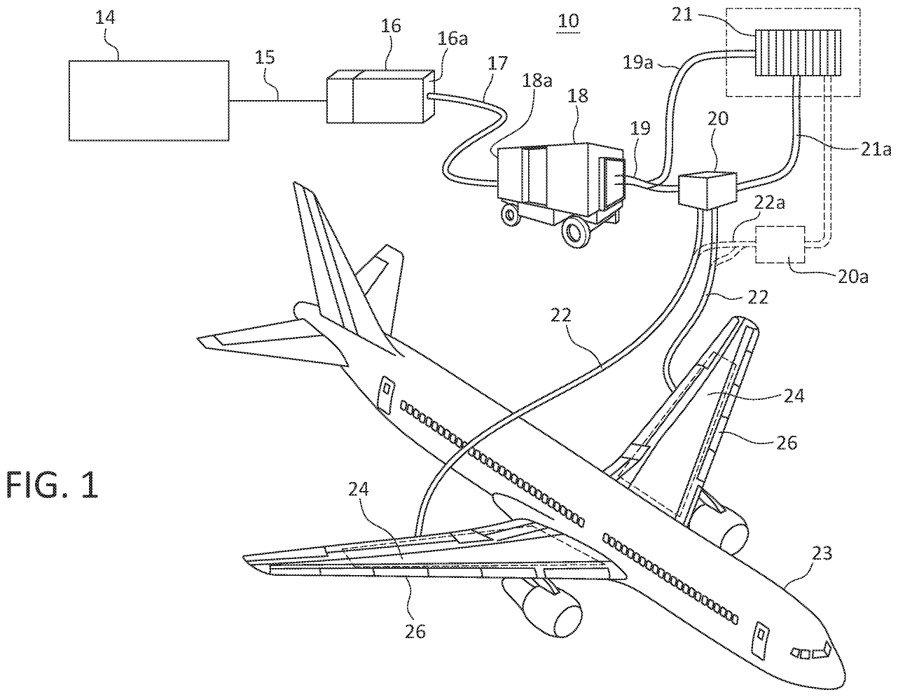

FIG. 1 is an illustration representing a charging system 10 according to present aspects. As shown in FIG. 1, renewable energy that can be, for example, in the form of solar energy, wind power, hydroelectric power, etc.), is collected at a renewable energy collection device 14, to form collected energy that can be converted into converted electrical energy. Accordingly, the renewable energy collection device 14 can be, for example, a solar panel array, a wind turbine, a hydroelectric turbine, etc. As used herein, the term “renewable energy” refers to energy that is not derived from fossil fuels and, instead is energy that is derived from a renewable energy source including, for example, solar power, wind power, water/hydro-electric power, etc.). As further shown in FIG. 1, the converted electrical energy is directed to a high-voltage capacitor 16 via power lines 15. The high-voltage capacitor 16 can incorporate or otherwise be in communication with at least one multiplexer. A first HTS cable 17 is in contact with and otherwise configured to connect the high-voltage capacitor 16 with the transformer 18. The capacitor and/or the transformer can incorporate or otherwise be in communication with at least one multiplexer 16a, 18a.

System 10 further shows a second HTS cable 19 in contact with and otherwise configured to connect the transformer 18 to a demultiplexer 20, with the demultiplexer 20 further including integrated relay circuitry (not shown in FIG. 1). The relay circuitry that can be dedicated relay circuitry is configured to deliver the converted electrical energy via delivery cables 22 to vehicle battery banks 24 of vehicle 23, in the form of an aircraft. Delivery cables 22 can further be HTS cables. As shown in FIG. 1, vehicle battery banks 24 are located within an aircraft wing assembly 26. FIG. 1 shows one location of the vehicle battery banks, such that the vehicle battery banks can are shown located in spaces formerly reserved for liquid fuel tanks. That is, according to present aspects, conventional aircraft fuel tanks can be replaced as a vehicle power supply by the vehicle battery banks. According to present aspects, the comparative weight of the vehicle battery banks can be balanced with respect to one another, and the comparative weight of the vehicle battery bank in total can approximate the weight of filled fuel tanks. Accordingly, the weight of the vehicle battery banks can be designed, for example, to not add weight to the overall vehicle weight as compared to a vehicle having full liquid fuel tanks.

In an alternate aspect, and as also shown in FIG. 1, system 10 can capture, collect, or “harvest” renewable energy from a renewable energy source such as solar energy, that is collected at a renewable energy collection device 14, in the form of a solar panel array, to form collected energy that can be converted into converted electrical energy. As further shown in FIG. 1, the converted electrical energy is directed to a high-voltage capacitor 16 via power lines 15. A first HTS cable 17 is in contact with and otherwise configured to connect the high-voltage capacitor 16 with the transformer 18. Another HTS cable 19 is configured to connect the transformer 18 to a demultiplexer 20. In an alternate aspect, system 10 further shows s second HTS cable 19a in contact with and otherwise configured to connect the transformer 18 to an electrical energy storage bank 21 (referred to equivalently herein as a “renewable energy storage bank”). Another HTS cable 21a in communication with the demultiplexer 20. In this alternate aspect, the converted electrical energy is sent directly from the transformer 18 to the electrical energy storage bank 21 via the second HTS cable 19a, or (in a storage bank charging cycle or mode) from the transformer 18 to the demultiplexer 20 via the HTS cable 19 to the demultiplexer 20 and then through the HTS cable 21a to the electrical energy storage bank 21 (referred to equivalently herein as an “electrical energy storage bank”). In addition, though not specifically shown in FIG. 1, the transformer 18 can incorporate at least one demultiplexer to condition and increase the charges sent from the transformer to the electrical energy storage bank 21.

When a charging demand is recognized by the energy storage bank, converted energy stored in the storage bank can be delivered to the demultiplexer 20 and then delivered from the demultiplexer 20 via the delivery cables 22 to the vehicle battery banks 24 shown located in wing assembly 26 of vehicle 23 to be charged, with vehicle 23 shown in FIG. 1 as an aircraft. Delivery cables 22 can further be HTS cables. The alternate aspect allows for the storage of converted energy into storage banks, for example, during daytime (e.g., when solar energy can be captured and converted), with the release of the converted energy from the storage bank to the vehicle battery banks occurring in either daytime or nighttime. Such arrangement allows the present systems to be used at hours other than daylight hours, as harvested solar energy can be collected, converted and stored during the daylight hours, and then released and delivered for charging a vehicle battery after daylight hours.

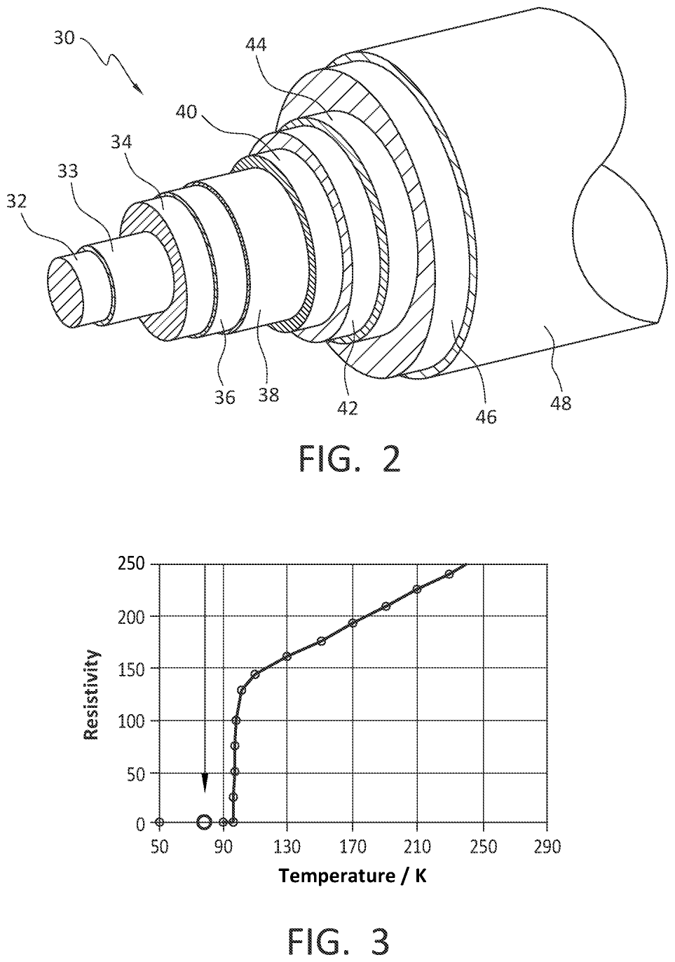

FIG. 2 is a partially exposed view of a representative HTS cable used in accordance with the methods, systems, and apparatuses of the present disclosure, and in according to present aspects. As shown in FIG. 2, moving from the center outward, HTS cable 30 includes a core 32 that can be a copper core positioned adjacent to and within a HTS tape layer 33 that is surrounded longitudinally by a high-voltage dielectric layer 34 that is surrounded longitudinally by a HTS shield layer tape layer 36 followed by a copper shield wire layer 38. As further shown in FIG. 2, the copper shield wire layer 38 is surrounded longitudinally by a liquid nitrogen coolant flow 40 that, during operation, can be delivered between the copper shield wire layer 38 and the thermal superinsulator 42 to cool the HTS cable 30 to a temperature ranging from about −30° C. to about 45° C. (e.g., the predetermined operational temperature range of the HTS cables selected, according to present aspects). As further shown in FIG. 2, HTS cable 30 includes inner cryostat wall 44 adjacent to outer cryostat wall 46, with the outer protective coating 48 shown as longitudinally surrounding the outer cryostat wall 46.

The HTS cables used in the methods, systems, and apparatuses and according to present aspects, can deliver electrical energy from the capacitor to the transformer at a rate ranging from about 1 MWh to about 250 MWh. Further, the HTS cables used in the methods, systems, and apparatuses and according to present aspects can transfer and deliver electrical energy from the capacitor to the transformer (and from the transformer to the storage banks, and from the transformer and from the storage banks to the vehicle battery banks) at a rate ranging from up to about 800 MW to about 1000 MW.

According to present aspects, the incorporation of the HTS cable allows the transference of very high voltages at high energy distribution rates as the HTS cables operate at low temperatures that result in a significant drop in resistance. The distribution rate at which the presently disclosed systems can transfer electrical energy through the system and to an object for the purpose of charging a battery bank (e.g., a storage battery bank and a vehicle battery bank) within a specified timeframe is important to the viability of a charging system or charging “station” used to charge batteries and then re-charge depleted rechargeable batteries in vehicles including, for example, passenger aircraft. For example, present methods, systems, and apparatuses deliver high voltages to vehicle battery banks at a charging rate ranging from about 25 MWh to about 1000 MWh such that, according to present aspects, a vehicle can be fully charged to operate over a flying range at least equivalent to that achieved using/burning fossil fuels, with the vehicle range that is possible for vehicles charged according to present apparatuses, systems, and methods is restricted only by the electrical energy storage capacity of the battery banks in the vehicle.

While not being bound to a single theory, it is believed that system efficiency and charge delivery from a vehicle battery storage bank to power a vehicle is improved through the charging of a series, or a plurality, of separate rechargeable battery cells. According to one illustrative example, if the vehicle shown in FIG. 1 has two battery banks (one in each wing), each battery bank can include any desired number of separate rechargeable battery cells, including rechargeable lithium ion batteries (equivalently referred to herein as “lithium ion battery cells”). According to present aspects, electrical power is delivered at a rate ranging up to about 1000 MW and is delivered to a rechargeable battery at a rate of ranging from about 25 MWh to about 1000 MWh, each rechargeable battery cell can be substantially fully charged to a charging capacity in a time duration ranging from about 60 mins. to about 180 mins, or less.

According to present aspects, the ability to deliver a full charge to a passenger aircraft vehicle, for example, within a specified time duration ranging from about 1 hour to about 3 hours, or less, facilitates the planning and scheduling that is used, for example, in the airline industry, as the profitability of the enterprise can be, at least partially, dependent upon an aircraft carrying a certain number of people between scheduled destinations in a certain amount of time, and the number of scheduled routes each aircraft can fly in a specified period of time (e.g., daily, etc.).

The present methods, systems, and apparatuses address and solve several problems presented regarding the repeatable, scheduled, reliable, etc. delivery of vast amounts of renewable energy to power a large vehicle (e.g., a passenger aircraft) in a short, scheduled duration such that the use of renewable electrical energy as an energy source is not just theoretical, but can be implemented into a practical, reliable, cost-effective, and sustainable way that does not impact a geographic electrical energy grid. According to present aspects, the use of a renewable energy source (e.g., solar power, wind power, hydroelectric power, etc.) solves the issues that would otherwise exist regarding the diversion of vast amounts of electricity from an established “grid” and used to power the electricity/power needs of a certain geographic area.

The use and integration into present systems of HTS cables allows the reliable and safe transfer of extremely large amounts of electricity from an energy source (including, for example, from an energy storage facility or device) to a passenger vehicle at high rates of efficient energy transfer, and electrical energy delivery that facilitates not only the charging of rechargeable battery cell banks in a large vehicle within a required and scheduled time duration that is similar to fossil fuel refueling times, and that can also deliver vast amounts of electricity to and from energy storage (e.g., energy storage banks, etc.), and from the energy storage to a rechargeable battery cell bank in a vehicle without the generation of significant amounts of heat that would otherwise be realized, and that otherwise could pose significant safety concerns, or that could otherwise make such a system impractical and unsafe.

According to further aspects, the HTS cables affect the efficient transfer of electrical energy at low temperatures that not only satisfy safety concerns, but that also facilitate the quick delivery of vast amounts of energy at a significantly low resistance and at low operational temperatures of such cables. FIG. 3 is a graph plotting resistance versus temperature/° K. As shown in FIG. 3, at very low temperatures, electrical resistance drops significantly. Since the HTS cables that are incorporated into the present apparatuses and systems operate at a temperature ranging from about −30° C. to about 45° C., during a charge delivery cycle, when electrical power at a rate of up to about 1000 MW is passed through the systems according to present aspects, a temperature increase (a temperature increase change compared to ambient temperatures) of only about 25° C. is realized. That is, the energy collection, energy storage, and energy dispensing/delivery systems (e.g., charging systems) according to present aspects are designed to deliver total amounts of energy at the desired charging voltages within the required time frames to substantially fully charge passenger vehicle battery banks with the disclosed systems operating within a temperature range ranging from about −30° C. to about 45° C.

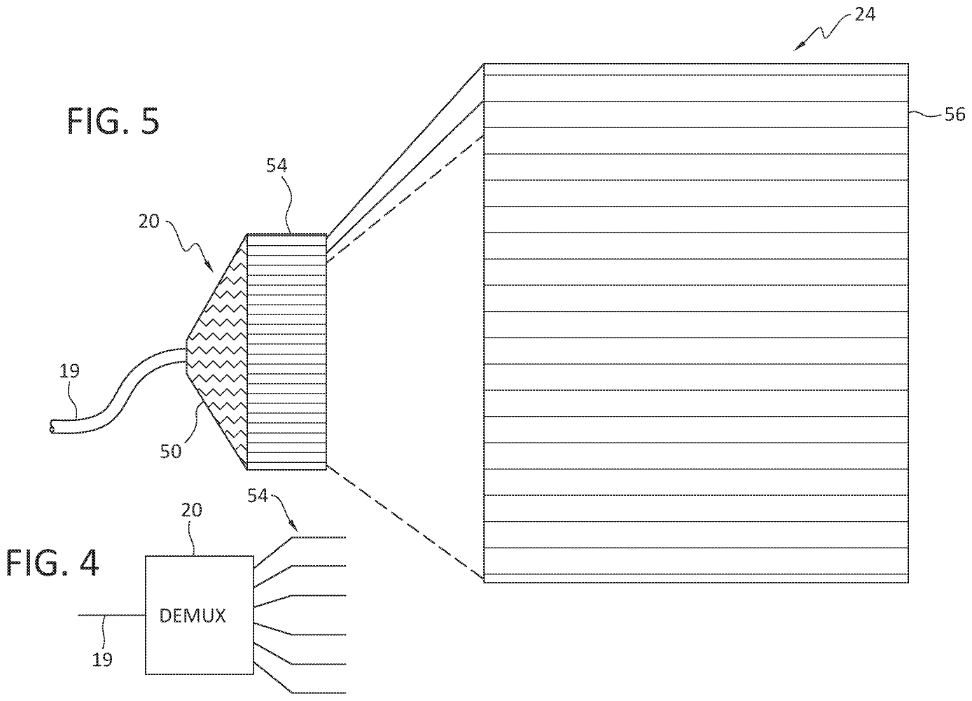

FIG. 4 is an illustration of a representative demultiplexer that can be implemented, according to present aspects, that facilitates the separation and delivery of electrical charges from a transformer to separate battery cells that, taken together, can comprise, for example, a vehicle battery bank or a storage battery bank, both of which can be rechargeable.

A demultiplexer (or demux) is a device taking one main input power line into the demux, with the incoming power then routed from the demux via several output lines. A demux of 2ⁿ outputs has “n” number of select lines that are used to select from which output line to send the power received from the input. A demultiplexer of the type disclosed herein can also be referred to equivalently as a type of “power distributor” and are designed to divide voltage and branch them the multiplexers could be solid state or mechanical-electro relay. Depending on the amount of power is going through them.

As shown in FIG. 4, demultiplexer 20 is in communication with second HTS cable 19 connecting the transformer 18 (not shown in FIG. 4, but as shown in FIG. 1) and demultiplexer 20. Demultiplexer 20 is further shown in communication with (or as otherwise integrally comprising as a part of the demultiplexer) individual relay circuits 54 with leads that can deliver converted electrical energy from the demultiplexer to a vehicle battery bank or a storage battery bank locate remotely from a vehicle.

FIG. 5 is an illustration of a representative demultiplexer that facilitates the separation and delivery of electrical charges from a transformer to separate battery cells that, taken together, comprise a passenger vehicle battery bank or a storage battery bank. According to present aspects, FIG. 5 shows an enlarged representative view of a demultiplexer of the type incorporated into present systems and shown, for example, in FIG. 1. As shown in FIG. 5, demultiplexer 20 is in communication with second HTS cable 19 connecting the transformer 18 (not shown in FIG. 4 or FIG. 5, but as shown in FIG. 1) and demultiplexer 20. As further shown in FIG. 5, demultiplexer 20 includes an integrated superconducting voltage divider 50 (referred to equivalently here as a superconducting “splitter”) that is further in communication with individual relay circuits 54 that can be integrated into or that are otherwise in communication with demultiplexer 20.

As further shown in FIG. 5, an individual circuit in the demultiplexer can be responsible for delivering an individual charge to an individual battery cell 56 in the rechargeable vehicle battery bank 24 that will occupy a space in, for example, a vehicle interior (e.g., a passenger aircraft wing interior, etc.) as shown in FIG. 1, or the individual charges can be directed, if desired to individual cells in a battery storage bank located remotely from the vehicle and that is a part of the overall system and that can be used to store harvested/collected renewable energy that has been converted into converted electrical energy. The stored electrical energy in the storage banks can then be delivered to a rechargeable vehicle battery on demand by electrical energy delivery cables that can be HTS cables from the storage bank to the rechargeable vehicle battery cells. As shown in FIG. 5, the individual battery cells 56 are shown in a stacked orientation to form the vehicle battery bank 24, that is not drawn to scale.

According to further present aspects, battery cell banks can include a plurality of rechargeable lithium-ion (herein also denoted as “Li-ion”) battery cells that can be arranged, for example, in a stacked or a side-by-side configuration, etc., with the Li-ion cells made according to a predetermined shape that can be dimensioned such that the Li-ion cell, or a plurality of appropriately dimensioned Li-ion battery cells can be housed in a battery cell cavity, that can be located in a vehicle such as, for example, the interior of an aircraft wing, etc. (e.g., a cavity that formerly housed, for example, an aircraft fuel tank, etc.).

The Li-ion battery cells can be dimensioned such that the dimension of the plurality of cells vary relative to one another and are dimensioned individually, or in concert, to substantially completely fill (or otherwise “fit” within) a regular or an irregular cavity space when assembled into an interior cavity, void, or other holding space in the vehicle (e.g., a passenger aircraft wing interior, including, for example, a passenger aircraft wing interior that formerly housed, for example, a liquid fuel tank, etc.). In other words, according to present aspects, the vehicle battery cell bank that can comprise a plurality of individual rechargeable Li-ion battery cells (or that can comprise one large battery cell) can be shaped and otherwise dimensioned to occupy the holding space, etc.

According to present aspects, Table 1 sets forth various battery types, the operating temperatures of a battery type it receives a charge, specified charging rates, and the duration required to achieve a charge at a specified charging rate.

TABLE 1

| | | | | Temperature | |
|---|---|---|---|---|---|
| | | | | Range (° C.) | |
| Charging | Battery | Charging Rate | Duration to | During | Charge |
| Type | Chemistry | (Coulombs, C) | Full Charge | Charging | Termination |
| Slow charge | NiCd; lead | 0.1 C | 14 hr. | 0° C. to 45° C. | Subject to |
| | | | | | overcharge/battery |
| | | | | | removal upon |
| | | | | | charge required |
| Rapid Charge | NiCd; Ni MH; | 0.3 to 0.5 C | 3 to 6 hr. | 10° C. to 45° C. | Sensing battery |
| | Li-ion | | | | voltage, current |
| Fast Charge | NiCd; NiMH; | 1 C | 1 hr+ | 10° C. to 45° C. | Sensing battery |
| | Li-ion | | | | voltage, current |
| Ultra-Fast | Li-ion, NiCd, | 1-10 C | 10-60 min. | 10° C. to 45° C. | |
| Charge | NiMH | | | | |

Traditional charging times for vehicle batteries requiring significant range of operation, and other roadblocks have hindered the practical use of electricity as a fuel source for passenger aircrafts. That is, in accordance with regulatory and operational demands, refueling an aircraft must be conducted within practical time constraints. According to present aspects, the following Example outlines a charging event for a large vehicle such as a passenger aircraft that can be charged in a fashion that replaces the fossil fuel refueling that typically occurs at a gate of an airport.

According to present aspects, potentially prior to an aircraft's arrival at a gate, an amount of radiant or solar energy has been collected by the renewable energy collection device (e.g., solar array) and converted from the collected solar energy to converted electrical energy. The converted electrical energy is further processed by a capacitor that itself stores an amount of energy, or that is communication with energy storage banks. The converted electrical is directed through a transformer via HTS cable(s) and then directed to a demultiplexer. The demultiplexer comprises or is otherwise in communication with a plurality of dedicated circuits designed and otherwise configured to direct and distribute an electrical charge of the converted and stored electrical energy from the multiplexer to a vehicle battery cell or among a plurality of individual vehicle battery cells (e.g., individual rechargeable Li-ion vehicle battery cells) in the vehicle battery bank. The totality of components comprises an apparatus or system that collectively is referred to as a “charging station”. Upon connecting a charging station outlet to a vehicle charging inlet, the vehicle is in condition to receive a charge from the charging station. In the charging mode, according to present aspects, the demultiplexer in combination with the HTS cables can deliver an electrical charge to a plurality of vehicle battery cells within the vehicle battery bank at a charging rate of from about 25 MWh to about 100 MWh. According to present aspects, the significant rapid charge duration would is selected to satisfy a vehicle's charging demands and is further selected to satisfy the refueling period duration between flights, with an interim gate time of an aircraft between flight, with the selected refueling duration ranging from between about 1 hour to about 3 hours.

When the renewable energy resource is other than solar power (e.g., wind power, hydroelectric power, etc.), the collection device can include a turbine that can be, for example, a wind turbine or a hydroelectric turbine, etc. The systems, apparatuses, and methods described herein, as well as the components of such systems and apparatuses described herein (e.g., the capacitor, transformer, multiplexer, demultiplexer, delivery circuits, HTS cable(s), battery cells, and battery cell banks, etc.), can be incorporated with a predetermined non-solar renewable energy collection device to collect, store, and distribute energy collected from the preselected non-solar renewable energy source, in similar fashion to that described for the solar energy collection, storage and distribution, including the voltage delivery rates, charging times, etc. as described herein.

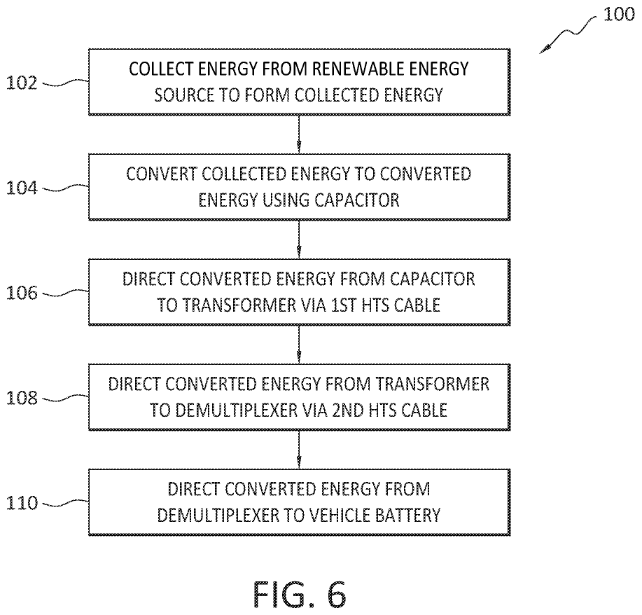

FIGS. 6-10 are flowcharts outlining present methods according to present aspects. As shown in FIG. 6, a method 100 includes collecting 102 energy from a renewable energy source to form an amount of collected electrical energy, converting 104 the collected electrical energy using at least one capacitor to form converted electrical energy; directing 106 converted electrical energy from the at least one capacitor via a first high temperature super conducting cable to a transformer, directing 108 converted electrical energy from the transformer via a second high temperature super conducting cable to a demultiplexer. The method further includes directing (equivalently referred to herein as “distributing”) 110 converted electrical energy from the demultiplexer substantially equally to a plurality of rechargeable vehicle batteries. In this aspect, converted electrical energy from the transformer is directed to the rechargeable vehicle battery via the demultiplexer without necessarily first storing energy in a storage bank (e.g., with the storage bank located externally and remotely from the vehicle, etc.).

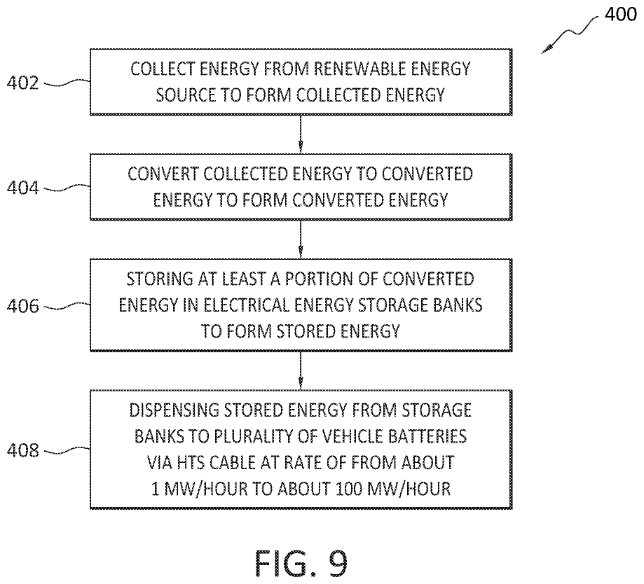

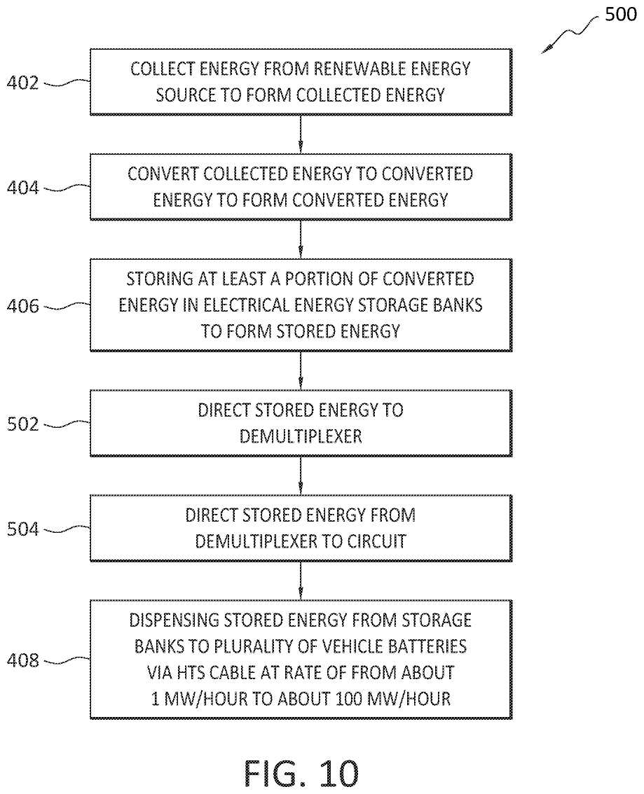

According to alternate aspects, described more fully in connection with FIGS. 9 and 10, present methods can include aspects shown in at least FIGS. 1, 2, 4, 5, and 6 that include collecting 102 energy from a renewable energy source to form an amount of collected electrical energy, converting 104 the collected electrical energy using at least one capacitor to form converted electrical energy; directing 106 converted electrical energy from the at least one capacitor via a first high temperature super conducting cable to a transformer, directing 108 converted electrical energy from the transformer via a second high temperature super conducting cable to a first demultiplexer 20, followed by distributing (equivalently referred to herein as “dispensing”) converted electrical energy from the first demultiplexer to an electrical energy storage bank and then optionally directing converted electrical energy from the electrical energy storage bank (and optionally to one or more additional demultiplexers), followed by directing converted electrical energy from at least one of the storage bank or the one or more demultiplexers 20a to a rechargeable vehicle battery 24a, for example, via further HTS cable 22a in communication with the demultiplexer 20a.

In an alternate aspect that, for example, contemplates charging a rechargeable vehicle battery at night (e.g., when solar power is not available to be collected in real time and directed in real time to an end use), converted electrical energy from the renewable energy source that has been previously collected and converted is directed to and stored in a storage bank. The converted and stored electrical energy is then directed from the storage bank, on demand, to the rechargeable vehicle battery.

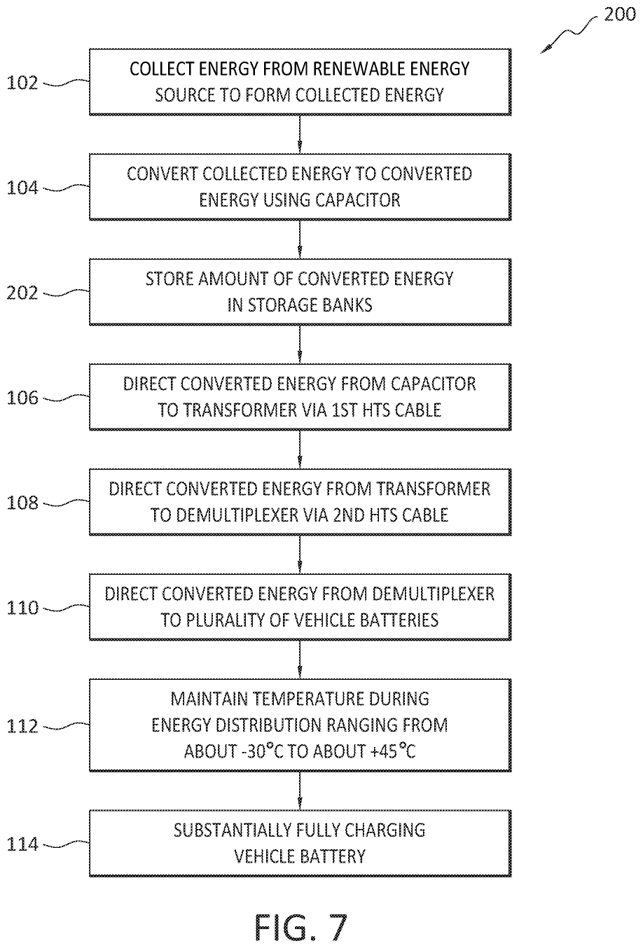

Whether the converted energy is directed to the rechargeable vehicle battery from the transformer, from the storage bank, or from both from the transformer and from the storage bank, the converted electrical energy can be directed to the rechargeable vehicle battery from at least one demultiplexer to substantially fully charge the rechargeable vehicle batteries while, as shown at least in FIG. 7, maintaining 112 the charging at a temperature ranging from about −30° C. to about 45° C. while substantially fully charging 114 a rechargeable vehicle battery, for example, at a charging rate ranging from about 25 MWh to about 100 MWh. Methods as shown at least in FIG. 6 can comprise the systems and apparatuses shown in one or more of FIGS. 1, 2, 4, and 5.

As shown in FIG. 7, a method 200 includes the steps (102, 104, 106, 108, 110, 112, 114) of method 100 shown in FIG. 6, with method 200 also including, after converting 104 the collected electrical energy using at least one capacitor to form converted electrical energy, storing 202 an amount of converted energy in a storage bank, with at least one of the capacitor and the transformer in communication with an energy storage bank. Present aspects contemplate substantially simultaneously (in the case of converting solar energy, for example, during daylight or daytime hours), directing converted electrical energy from a renewable energy source to at least one of and, if desired, to both of: 1) a rechargeable vehicle battery and/or rechargeable vehicle battery bank or banks; and 2) a converted electrical energy storage bank (e.g., located externally from and remotely from a vehicle to be charged). Further alternate aspects include delivering amounts of converted electrical energy to a rechargeable vehicle battery from either or both of the system in operation (while renewable energy is being captured and converted), and also from the storage bank (e.g., in alternating energy delivery cycles, or substantially simultaneously, etc.). Methods as shown at least in FIG. 7 can include the systems and apparatuses shown in one or more of FIGS. 1, 2, 4, 5 and 6.

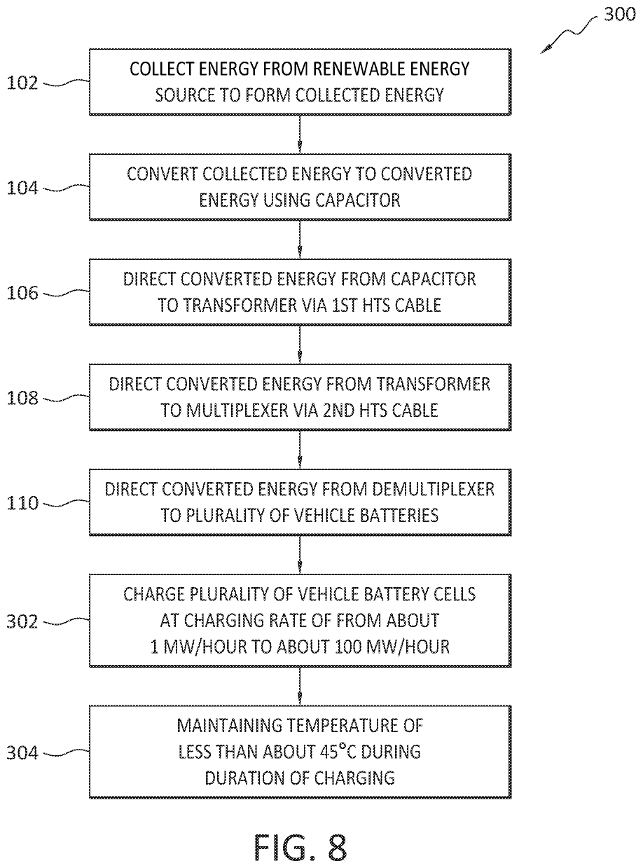

As shown in FIG. 8, method 300, can include the method 100 shown in FIG. 6, and further includes charging 302 a plurality of rechargeable vehicle batteries at a charging rate ranging from about 1 MWh to about 100 MWh, while maintaining 304 a temperature throughout the system of less than about 45° C. during the duration of energy distribution cycles. An amount of electrical energy at a rate ranging from about 250 MW to about 1000 MW of electrical energy can be distributed from the demultiplexer to the plurality of rechargeable vehicle batteries during a charging duration, and the rechargeable vehicle batteries can include rechargeable Li-ion batteries, and with the charging cycle durations ranging from about 1 to about 3 hours. Methods as shown in FIG. 8 can include the systems and apparatuses shown in one or more of FIGS. 1, 2, 4, 5, 6 and 7.

According to another present aspect shown in FIG. 9, a method 400 is disclosed including collecting 402 energy from a renewable energy source to form an amount of collected electrical energy, converting 404 the collected electrical energy using a capacitor to form converted electrical energy, storing 406 an amount of the converted electrical energy in a plurality of electrical energy storage banks to form an amount of stored electrical energy, and dispensing (e.g., directing) 408 an amount of at least one of the stored electrical energy or converted electrical energy directly from the system in the form of dispensed electrical energy from at least one of the electrical energy storage bank or a transformer to a plurality of rechargeable vehicle batteries via at least one high temperature superconducting cable and at least one demultiplexer, wherein dispensed electrical energy is delivered to the plurality of rechargeable vehicle batteries at a charging rate ranging from about 1 MWh to about 100 MWh. In another aspect, dispensed electrical energy is delivered to the plurality of rechargeable vehicle batteries at a charging rate ranging from about 25 MWh to about 100 MWh. Methods as shown in FIG. 9 can include the systems and apparatuses shown in one or more of FIGS. 1, 2, 4, 5, 6, 7 and 8.

In another aspect, as shown in FIG. 10, a method 500 includes the steps 402, 404, 406, and 408 shown in method 400 (shown in FIG. 9) and, after the step of storing 406 an amount of the converted electrical energy and before the step of dispensing 408 an amount of the stored electrical energy, the method further includes directing 502 an amount of the stored electrical energy from the electrical energy storage banks to a demultiplexer, and directing 504 electrical energy from the demultiplexer to a circuit (e.g., a relay circuit), with the circuit in communication with a plurality of rechargeable vehicle batteries. The methods outlined in FIGS. 6, 7, 8, 9, and 10 incorporate the systems and apparatuses described herein, including those presented in any of FIGS. 1, 2, 3, 4, and 5.

In the examples disclosed above, the charging system 10 relies on a renewable energy collection device 14 to supply the needed power. In another example, the charging system 10 receives power from an electrical power grid 90. In one example, the power from the power grid 90 is used to supplement the power that is supplied from the renewable energy collection device 14 or otherwise available within the charging system 10. In another example, the full power for the charging system 10 to charge a vehicle 23 is supplied by the power grid 90.

The power grid 90 supplies power when the charging system 10 is not otherwise able to meet the charging demands. This can occur during times of high usage of the charging system 10, such as but not limited to when multiple vehicles 23 are being simultaneously charged and the renewable energy collection device 14 provides little to no power to the charging system 10 or when the renewable energy collection device 14 is being serviced. Insufficient renewable energy supplied to the renewable energy collection device 14 can result from various conditions, including but not limited to solar panels providing little to no power during low light levels, and wind turbines providing little to no power during low wind conditions. During these times, the power grid 90 provides the power or otherwise supplements the needed the power. Additionally or alternatively, the power grid 90 provides power during off-peak hours. This can include low-usage times such as during nights, weekends, or various other low-usage times. The use of off-peak hours can provide a cost savings as electrical authorities often charge less for power during these times.

The power grid 90 is an interconnected network for delivering electricity. The power grid 90 can include various sizes and consists of various components, including but not limited to power stations, substations, and power transmission and distribution devices. The power grid 90 is synchronous and operates with three phase alternating current (AC) frequencies. In one example, the power grid 90 supplies three phase—4 wire, 480 VAC 60 Hz. The power grid 90 can receive its energy from one or both of renewable energy sources and non-renewable energy sources.

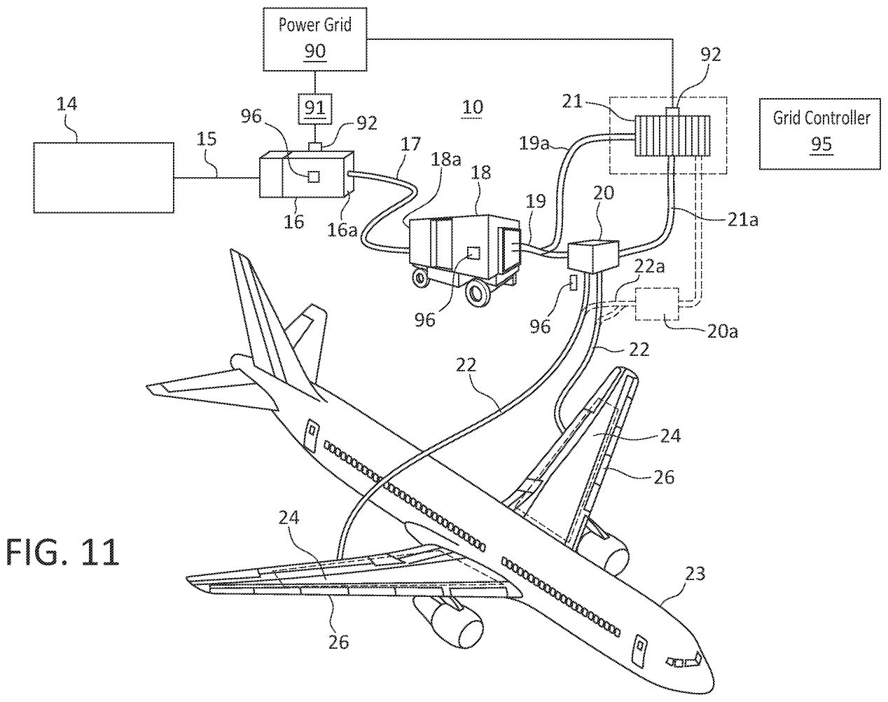

FIG. 11 illustrates the charging system 10 connected to the power grid 90 at one or more connections 92. The power grid 90 is connected to the charging system 10 at the capacitor 16. A converter 91 is positioned to convert the AC output from the power grid 90 into a form for receipt by the capacitor 16. In one example, the power is converted to match that supplied to the capacitor 16 from the renewable energy collection device 14. The power grid 90 is also connected at the storage bank 21.

The power grid 90 can be connected to the charging system 10 at one or more locations. FIG. 11 includes an example with two connections 92. Other examples include a single connection at various locations (e.g., at just the capacitor 16, at just the storage bank 21). In another example, the power grid 90 is connected at three or more locations.

A grid controller 95 controls the voltage and/or current of the charging system 10 by monitoring various conditions within the charging system 10. One or more sensors 96 positioned in the charging system 10 provide input for the grid controller 95 to determine operating conditions such as but not limited to power demand or power surplus conditions. Examples of sensors 96 include but are not limited to voltage sensors and current sensors that can detect conditions for individual components of the charging system 10 and/or overall conditions and loads of the charging system 10. The grid controller 95 monitors the conditions of the charging system 10 and determines when additional power is needed to be drawn through the power grid 90. When the grid controller 95 determines that the demand is within the level that can be supplied by the renewable energy collection device 14, the grid controller 95 limits the input to just the renewable energy collection device 14. When the grid controller 95 determines that the power demand exceeds the amount that can be supplied by the renewable energy collection device 14, the grid controller 95 receives additional power from the power grid 90.

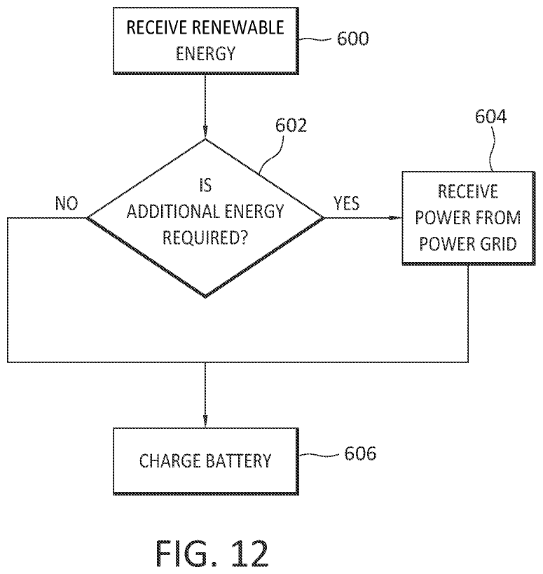

FIG. 12 illustrates a method of charging a battery bank 24 of a vehicle 23. The charging system 10 receives electrical energy at the renewable energy collection device 14 (block 600), the grid controller 95 determines whether additional electrical energy is needed (block 602). If no additional energy is needed, the charging system 10 continues to receive energy from just the renewable energy collection device 14. If additional energy is required, the charging system 10 receives electrical energy from the power grid 90 (block 604). The charging system 10 charges the battery of the vehicle 23 (block 606).

In one example, the charging system 10 charges the battery bank 24 using electrical power from just the renewable energy collection device 14. For example, during a sunny day when solar panels are able to provide the needed amount of electricity to charge the battery bank 24. In another example, the charging system 24 charges the battery bank 24 using a combination of energy from the renewable energy collection device 14 and energy stored at the storage bank 21. In another example, the power grid 90 supplements one or both of these methods. In another example, the power grid 90 provides the entire electrical energy that is needed to charge the battery bank 24. In one specific example, the charging occurs at a time when the renewable energy collection device 14 is not able to produce energy (e.g., night time) and the storage bank 21 is not able to provide energy (e.g., during a discharged state).

In one example, the determination that additional electrical energy is needed compares the amount of electrical energy that is being supplied by the renewable energy collection device 14 and the current demand. In another example, the determination also considers the amount of electrical energy that is being supplied by the renewable energy collection device 14 and the electrical energy storage bank 21. In one example, the determination considers when the collection device 14 is not or will not be in operation. Thus, the determination of the amount of available energy in the system 10 is determined from just the electrical energy that is stored in the storage bank 21.

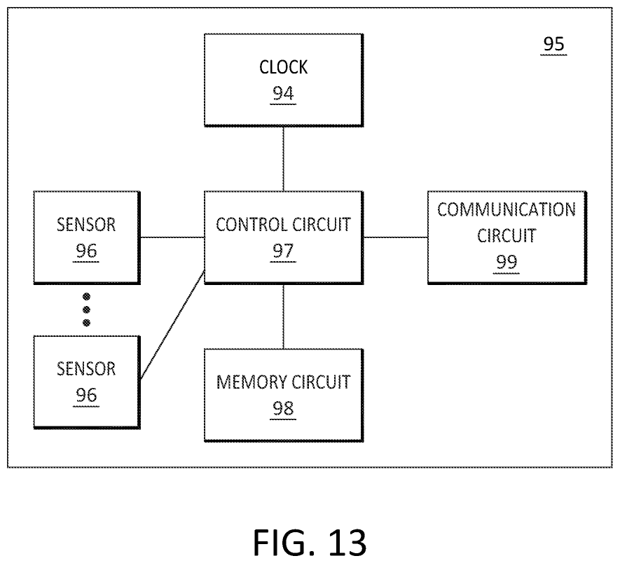

FIG. 13 schematically illustrates a grid controller 95 that controls the operation of the charging system 10. The grid controller 95 includes control circuitry 97 that includes one or more circuits, microcontrollers, microprocessors, hardware, or a combination thereof. Memory circuitry 98 includes a non-transitory computer readable storage medium storing program instructions such as a computer program product, that configures the control circuitry 97 to implement one or more of the techniques discussed herein. Memory circuitry 97 can include various memory devices such as, for example, read-only memory, and flash memory. Memory circuitry 97 can be a separate component or can be incorporated with the control circuitry 97.

Communications circuitry 99 provides for communication functionality to remote users. The communications circuitry 99 can provide for different methods of communication and can include one or more of a cellular interface that enables communication with a mobile communication network, and a WLAN interface configured to communicate with a local area network. The communication circuitry 99 can further include a personal area network interface, such as a Bluetooth interface, and a Near Field Communication interface that provides for short-range wireless connectivity technology that uses magnetic field induction to permit devices to share information with each other over short distances.

The one or more sensors 96 detect conditions within the charging system 10 and transmit the readings to the grid controller 95 for processing. A clock 94 provides for timing functionality that is used by the control circuitry 97 to determine peak and off-peak demand periods for receiving power from the power grid 90.

The charging system 10 is configured to dispense electrical energy in a wide variety of contexts and to a wide variety of vehicles. One example includes dispensing energy to aircraft. Other examples include but are not limited to dispensing electrical energy to road vehicles, rail vehicles, marine vehicles, and aerospace vehicles. The charging system 10 is configured to dispense electrical energy at different charging rates and/or dispense different amounts of electrical energy depending upon the context of use and/or the type of vehicle that is being charged. In one example, the charging system 10 is configured to charge a car or light truck and charge a battery with a capacity in a range between 50 kWh-100 kWh. In another example, the charging system 10 is configured to dispense energy for larger equipment such as aircraft, trains, and boats in a range between 25 MWh-1000 MWh.

The present aspects may, of course, be carried out in other ways than those specifically set forth herein without departing from aspects and characteristics of the disclosure. The present aspects are to be considered in all respects as illustrative and not restrictive, and all changes coming within the meaning and equivalency range of the appended claims are intended to be embraced therein.

What is claimed is:

1. A system for charging vehicles, the system comprising:
a renewable energy collection device configured to collect renewable energy from one or more renewable energy sources, the renewable energy source comprising at least one of solar power, wind power, and hydroelectric power;
a high-voltage capacitor in communication with the renewable energy collection device;
a first high temperature superconducting cable in communication with the high-voltage capacitor;
a transformer in communication with the first high temperature superconducting cable;
a second high temperature superconducting cable in communication with the transformer;
an electrical energy storage bank;
a power grid connection to receive energy from a power grid;
at least one demultiplexer in communication with the second high temperature superconducting cable, the at least one demultiplexer configured to engage a relay circuit, the relay circuit configured to deliver electrical energy to at least one rechargeable vehicle battery; and
wherein the at least one demultiplexer is configured to deliver electrical power up to 1000 MW to at least one of the electrical energy storage bank and the at least one vehicle battery.

2. The system of claim 1, wherein the power grid connection is configured to electrically connect the high-voltage capacitor to the power grid.

3. The system of claim 2, further comprising a converter to convert the energy from the power grid into a form for receipt by the high-voltage capacitor.

4. The system of claim 1, wherein the power grid connection is configured to electrically connect the electrical energy storage bank to the power grid.

5. The system of claim 1, wherein the power grid is connected to both of the high-voltage capacitor and the electrical energy storage bank.

6. The system of claim 1, wherein the system has an operating temperature range ranging from −30° C. to 45° C.

7. The system of claim 1, wherein the at least one demultiplexer comprises relay mechanisms, the relay mechanisms configured to distribute a predetermined amount of the electrical energy to the at least one vehicle battery.

8. The system of claim 1, wherein the renewable energy collection device is configured to deliver up to 250 MW to the high-voltage capacitor.

9. A method of charging a battery of a vehicle, the method comprising:
receiving at a charging system renewable electrical energy from one or more renewable energy sources;
determining that an additional amount of the electrical energy is needed;
in response to determining that the additional electrical energy is needed, receiving at the charging system additional electrical energy from a power grid; and
dispensing from the charging system electrical energy comprising both the renewable electrical energy and the additional electric energy and charging the battery of the vehicle.

10. The method of claim 9, further comprising directing the electrical energy to a demultiplexer prior to dispensing the electrical energy and charging the battery of the vehicle.

11. The method of claim 10, wherein dispensing the electrical energy comprises dispensing a first portion of the electrical energy from the demultiplexer and charging the battery, the method further comprising directing a second portion of the electrical energy from the demultiplexer to an electrical energy storage bank that is separate from the battery of the vehicle.

12. The method of claim 11, further comprising directing the first portion of the electrical energy to the battery prior to receiving the additional electrical energy.

13. The method of claim 11, further comprising receiving the additional electrical energy at the electrical energy storage device.

14. The method of claim 11, wherein the demultiplexer if a first demultiplexer, the method further comprising:
directing the electrical energy from the electrical energy storage bank to a second demultiplexer; and
dispending the electrical energy from the second demuliplexer to the battery of the vehicle.

15. The method of claim 14, further comprising simultaneously directing the electrical energy from the first demuliplexer and the second demultiplexer to the battery.

16. The method of claim 9, further comprising converting the renewable electrical energy to a different form prior to dispensing the electrical energy.

17. The method of claim 16, further comprising receiving the additional electrical energy from the power grid at a high-voltage capacitor.

18. The method of claim 9, wherein receiving the renewable electrical energy from the one or more renewable energy sources comprises receiving the renewable electrical energy from at least one of solar power, wind power, and hydroelectric power.

19. The method of claim 9, further comprising dispensing the electrical energy to the battery of the vehicle at a charging rate ranging between 100 kWh to 100 MWh.

20. A method of charging a vehicle, the method comprising:
collecting renewable energy from a renewable energy source to form collected electrical energy;
converting the collected electrical energy into converted electrical energy;
directing the converted electrical energy via a high temperature super conducting cable to a first demultiplexer;
distributing the converted electrical energy from the first demultiplexer to a battery of a vehicle and thereby charging the battery;
maintaining a temperature in a charging region of the battery below 45° C. during the charging;
distributing the converted electrical energy from the first demultiplexer to an electrical energy storage bank;
distributing the converted electrical energy from the electrical energy storage bank to a second demultiplexer;
wherein an amount of electrical energy is distributed ranging from 250 MW to 1000 MW from the second demultiplexer to the battery at a charging rate ranging from 1 MWh to 100 MWh.
